(19) United States
(12) Patent Application Publication
(10) Pub. No.: US 2013/0090946 A1
(43) Pub. Date: Apr. 11, 2013

(54) SYSTEMS AND METHODS FOR IMAGING WORKFLOW

(71) Applicants: Thomas Kwok-Fah Foo, Clifton Park, NY (US); Robert David Darrow, Scotia, NY (US); Kenji Suzuki, Tokyo (JP); Sandeep Narendra Gupta, Clifton Park, NY (US); Rakesh Mullick, Bangalore (IN); Vivek Vaidya, (US); Xiaodong Tao, Niskayuna, NY (US); Ting Song, Clarksburg, MD (US)

(72) Inventors: Thomas Kwok-Fah Foo, Clifton Park, NY (US); Robert David Darrow, Scotia, NY (US); Kenji Suzuki, Tokyo (JP); Sandeep Narendra Gupta, Clifton Park, NY (US); Rakesh Mullick, Bangalore (IN); Vivek Vaidya, (US); Xiaodong Tao, Niskayuna, NY (US); Ting Song, Clarksburg, MD (US)

(21) Appl. No.: 13/253,853

(22) Filed: Oct. 5, 2011

(51) Int. Cl. G06Q 50/24

(52) U.S. Cl. 705/3

(57) ABSTRACT

An imaging workflow system includes a workstation for acquiring patient information and requesting a patient scan. The request for a patient scan includes scan information for performing the scan. A registration module receives the scan information and the patient information. The registration module automatically schedules the patient scan based on the scan information and the patient information. The registration module determines an imaging protocol based on the patient information and the scan information. An imaging module within an imaging system receives the imaging protocol. The imaging module automatically sets scan parameters based on the imaging protocol. The imaging system scans the patient based on the scan parameters to acquire image data. A user interface controls the patient scan. The user interface includes a display to display images generated from the acquired image data.

### BACKGROUND

The subject matter described herein relates generally to imaging systems, and more particularly, to imaging system workflow.

Conventional imaging workflow requires a plurality of steps beginning with a practitioner ordering an imaging scan. The imaging scan order may include scan information, such as instructions for the purpose of the scan, as well as, preferred scan parameters for the scan. Patient information may also be acquired to generate a scan protocol specific to the patient. The scan information and patient information are delivered to an imaging facility where a scan is scheduled and performed based on the scan information and patient information.

However, conventional imaging workflow requires significant manual input and is often slow. For example, the imaging scan order must first be processed at the imaging facility to register the patient. Processing is generally performed manually with a registrar determining the type of scan to be performed (e.g. modality, scan parameter), as well as, the availability of an imaging module. The processing may also include time consuming data entry for billing. Further, the imaging process typically requires highly trained technologists to carefully set and control the scan parameters. Control of the imaging module often requires significant operator experience. For example, imaging modules are typically controlled using a keyboard type interface. Accordingly, patient information and scan parameters are required to be manually input and controlled. The patient scan is then controlled by entering information using the keyboard, which can be tedious and subject to error.

Moreover, image analysis for the determination of necessary clinical information is often conducted by lengthy post processing that may require further manual input. This reduces patient throughput, affects patient experience, may result in sub-optimal image quality, and increases the cost of the imaging process.

### SUMMARY

In one embodiment, an imaging workflow system is provided. The system includes a workstation for acquiring patient information and requesting a patient scan. The request for a patient scan includes scan information for performing the patient scan. A registration module receives the scan information and the patient information. The registration module automatically schedules the patient scan based on the scan information and the patient information. The registration module determines an imaging protocol based on the patient information and the scan information. An imaging module within an imaging system receives the imaging protocol. The imaging module automatically sets scan parameters based on the imaging protocol. The imaging system scans the patient based on the scan parameters to acquire image data. A user interface controls the patient scan. The user interface includes a display to display images generated from the acquired image data.

In another embodiment, a method for providing imaging workflow includes automatically scheduling a patient scan based on acquired patient information and scan information for performing the patient scan. An imaging protocol is automatically determined based on the scan information and the patient information. Scan parameters are automatically set based on the imaging protocol. The patient is scanned based on the scan parameters to acquire image data. The patient scan is controlled at a user interface. Images generated from the acquired image data are displayed on a display.

In yet another embodiment, a non-transitory computer readable storage medium for providing imaging workflow using a processor includes instructions to command the processor to automatically schedule a patient scan based on acquired patient information and scan information for performing the patient scan. The instructions further command the processor to automatically determine an imaging protocol based on the acquired patient information and the scan information. The instructions also command the processor to automatically set scan parameters based on the imaging protocol and scan the patient based on the scan parameters to acquire image data. The instructions additionally command the processor to display images generated from the acquired image data on a display.

### BRIEF DESCRIPTION OF THE DRAWINGS

The presently disclosed subject matter will be better understood from reading the following description of non-limiting embodiments, with reference to the attached drawings, wherein below:

FIG. 1 is a schematic block diagram illustrating imaging workflow in accordance with an embodiment.

FIG. 2 is a schematic block diagram of a user interface formed in accordance with an embodiment.

FIG. 3 is a view of a menu displayed on the user interface shown in FIG. 2.

FIG. 4 is a flowchart of a method of scheduling using the system shown in FIG. 1 in accordance with an embodiment.

FIG. 5 is a flowchart of a method of patient registration using the system shown in FIG. 1 in accordance with an embodiment.

FIG. 6 is a flowchart of a method for scanning workflow using the system shown in FIG. 1 in accordance with an embodiment.

FIG. 7 is a flowchart of a method of image acquisition using the system shown in FIG. 1 in accordance with an embodiment.

FIG. 8 is a flowchart of a method for image analysis and reporting using the system shown in FIG. 1 in accordance with an embodiment.

FIG. 9 is a schematic block diagram illustrating imaging workflow in accordance with various embodiments.

FIG. 10 is a flowchart illustrating a method for imaging workflow in accordance with various embodiments.

### DETAILED DESCRIPTION

The foregoing summary, as well as the following detailed description of certain embodiments, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers, circuits or memories) may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As used herein the term “module” refers to software, hardware, for example, a processor, or a combination thereof that is programmed with instructions for carrying an algorithm or method. The modules described herein may communicate through a wired connection, for example, a local area network, or the modules may communicate wirelessly.

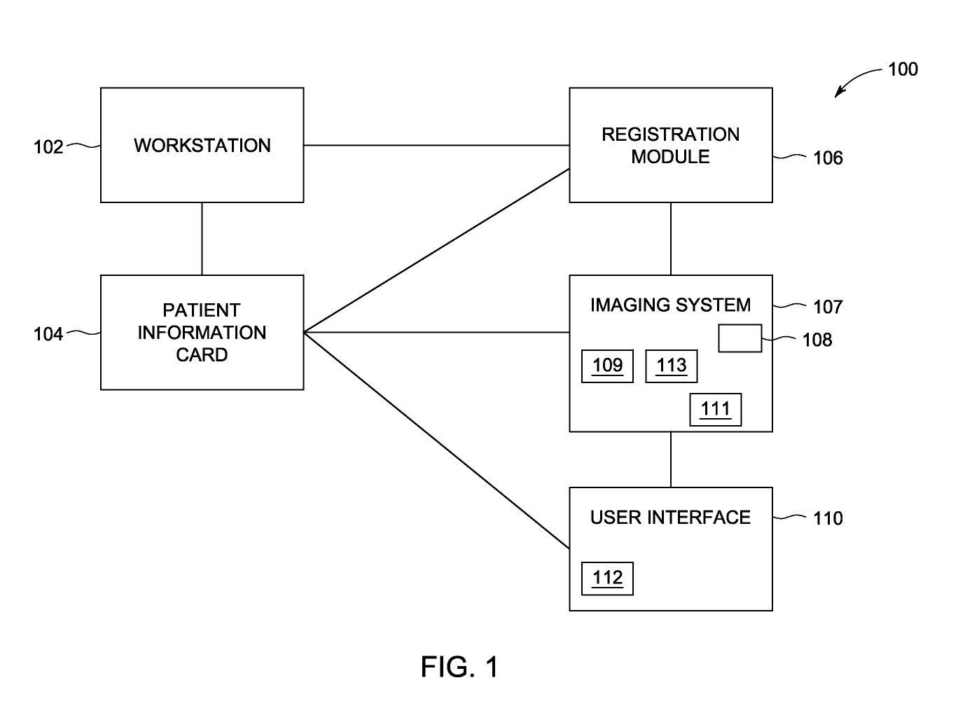

FIG. 1 is a schematic block diagram illustrating an imaging workflow system 100 formed in accordance with an embodiment. The imaging workflow system 100 includes a workstation 102. The workstation 102 may be located at a physician's office, a hospital, or other medical facility. In one embodiment, the workstation 102 may be a portable workstation that is capable of being transported to a patient's home, a nursing home, a rural area or any other area with limited access to a doctor's office. The workstation 102 may be a computer and/or a hand-held device, for example, a laptop, smart phone, electronic tablet type device, or the like. After an initial examination, the physician may determine that an imaging scan is required for the patient. Accordingly, the physician may request a patient scan by inputting, into the workstation 102, scan information indicative of a type of scan to be performed. The scan information may include a modality of scan and/or a purpose for the scan (e.g. to determine the effectiveness of lesion treatment). The scan information may also contain information regarding an anatomy of the patient to be scanned.

The physician, a nurse, and/or a staff member may also input patient information into the workstation 102. For example, on an initial visit, patient information may be entered related to background information, such as patient address and insurance information, as well as, physical information, such as patient height, weight, age, allergies, medical history or the like. On subsequent visits, the patient information may be updated. In one embodiment, the patient information is downloaded onto a patient information card 104 that the patient retains. The patient information card 104 may include a bar code, a magnetic strip, or the like for retrieving data from the patient information card 104. The patient information card 104 may be a radio frequency identification device (RFID). In one embodiment, the patient information card is a high capacity holographic card. The patient information card 104 may also be encrypted and require a pin number or password to retrieve data therefrom. In one embodiment, the patient information card 104 may also be downloaded with the scan information. For example, the scan request issued by the physician may be stored electronically on the patient information card 104 for future retrieval at an imaging facility. In one embodiment, a high level prescription or scan request is downloaded to the patient information card 104. For example, the high-level scan request may be a general prescription order, such as, “knee exam”, “torn meniscus”, “rule out brain tumor”, or “repeat exam of xx/xx/xx date”. In another embodiment, the scan request may be explicit and specify exact protocols or specific sequences and scan parameters. The scan request may include information for an entire patient exam including multiple series of images.

The scan information and the patient information are electronically transmitted to a registration module 106. The registration module 106 may be located at an imaging facility wherein the patient scan is to take place. Alternatively, the registration module may be located at a remote facility that performs scheduling for an affiliated imaging facility. The scan information and the patient information may be electronically transmitted via a secure website or the like. Alternatively, the scan information and the patient information may be retrieved from the patient information card 104.

The registration module 106 utilizes the scan information and the patient information to automatically schedule the patient scan. In one embodiment, the registration module 106 may include an expert system having logic that translates a high-level scan request into a specific scan request, such as a specific scan protocol. For example, the high-level scan request may include the instruction “knee exam”. A plurality of scan protocols may exist for “knee exam”. The expert system selects an appropriate scan protocol based on at least one of the high-level scan request, the scan information, and the patient information. In one embodiment, the expert system uses a logic based approach to determine specific sequences, protocols, and parameters to fulfill the scan request.

In one embodiment, the patient scan is scheduled based on the imaging module required and the purpose of the patient scan. The registration module 106 automatically determines the availability of equipment and schedules the patient scan accordingly, for example, from an electronic scheduling list. The registration module 106 may select a site for the patient scan that meets the needs of a particular scan protocol for a specific problem or disease. The registration module 106 may also determine whether any accommodations must be made for the patient based on the patient information, such as patient height and weight, allergies, claustrophobia, or contraindications.

In one embodiment, the registration module 106 automatically determines the billing and insurance information for the patient based on the patient information. Accordingly, at the time that the patient arrives for the patient scan, the scan has been scheduled and the billing and insurance information for the patient has been determined. Accordingly, the patient can submit the patient information card 104 for identification and proceed to the imaging room without spending significant time during registration.

The system 100 also includes an imaging system 107. The imaging system 107 may be a medical diagnostic or interventional scanner. For example, the imaging module may be a Positron Emission Tomography (PET) system, a Single Photon Emission Computed Tomography (SPECT) system, a Magnetic Resonance Imaging (MRI) system, an X-ray system, or the like. The imaging system 107 may include peripheral devices, such as a wireless electrocardiogram 109, integrated headphones 111, and/or a LED display 113. The imaging system 107 may be located in the same facility as the registration module 106. Alternatively, the imaging system 107 may be located at a remote imaging facility, such as a dedicated imaging center. The scan information and the patient information are electronically transmitted to the imaging system 107. In one embodiment, the scan information and the patient information are electronically transmitted via a secure network or the like. Optionally, the scan information and the patient information may be retrieved from the patient information card 104, such as using a suitable card reader. In one embodiment, the imaging system 107 may include the expert system having suitable logic (hardware, software or a combination thereof) that translates a high-level scan request into a specific scan protocol.

The imaging system 107 includes an imaging module 108 that automatically sets scan parameters based on the scan information and the patient information. In one embodiment, the scan parameters may be adjusted by a technician, such as with the user interface 110. The imaging system 107 performs a scan of the patient based on the scan parameters and acquires image data. The user interface 110 is in communication with the imaging system 107, and may be formed integrally with the imaging system 107 and/or may be a remote hand-held device, for example, a smart phone, laptop, electronic tablet type device, or the like. The user interface 110 may be operated at the location of the imaging system 107 (e.g. in the scan room) and/or remotely from the imaging system 107 (e.g. in a control room).

The user interface 110 may be used to control the scan of the patient, including before, during, and after image acquisition. For example, in one embodiment, the user interface 110 may be used in a remote rural location by a physician to control the imaging system 107 at an imaging facility. The user interface 110 may be operated to control scan parameters, change scan planes, or the like. In an exemplary embodiment, the user interface 110 includes a display 112 that displays acquired images on the user interface 110 in real time. The display 112 accommodates real time control over the imaging system 107. After image acquisition, the user interface 110 may be used for analysis of the image data. For example, a patient report may be generated using the user interface 110. The user interface 110 may then electronically transmit the image data and the patient report back to the workstation 102 for review by the physician. Thus, the physician can diagnose the patient, determine the effectiveness of a treatment, or the like.

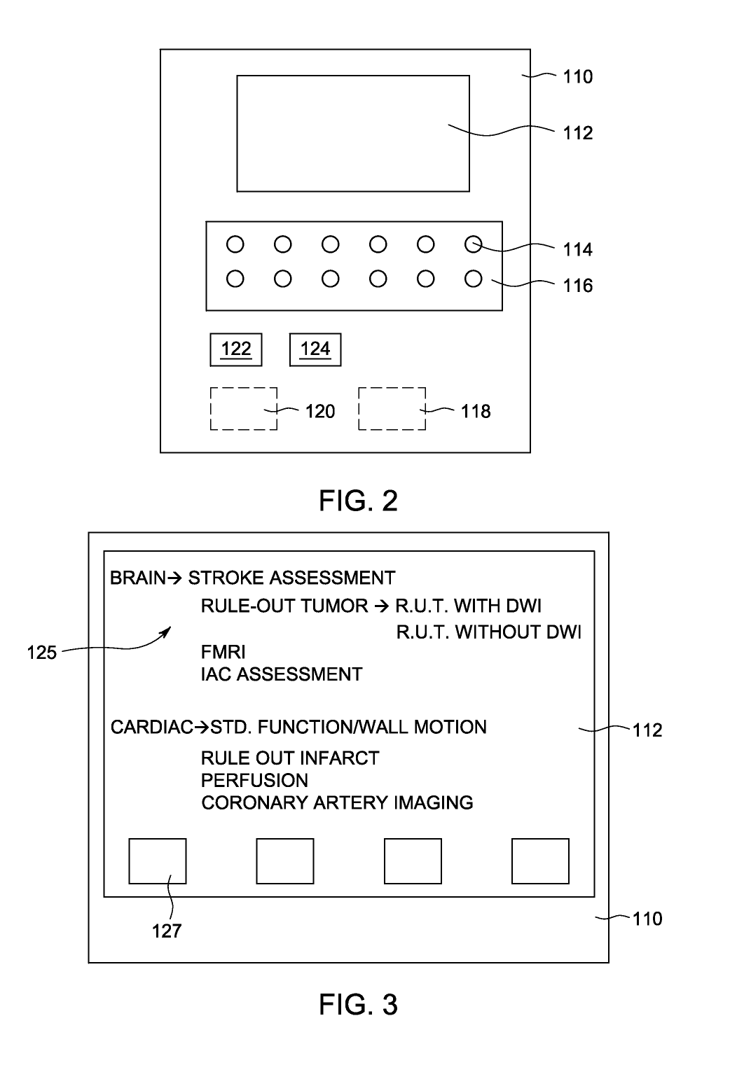

FIG. 2 is a schematic block diagram of the user interface 110. FIG. 2 illustrates the user interface 110 as a portable hand-held device. The user interface 110 provides remote control of the imaging system 107 (shown in FIG. 1). For example, the user interface 110 is untethered from the imaging system 107 and may be used remotely therefrom, inside or outside of the imaging room. For example, a physician may use the user interface 110 from an office that is remote from the imaging facility. In another example, a physician may use the user interface 110 in a remote rural area. Alternatively, a surgeon may directly control the imaging system 107 while performing a procedure from different locations from within the imaging facility or room. The user interface 110 communicates with the imaging system 107 to exert control over functions, such as image acquisition. In an exemplary embodiment, the user interface 110 wirelessly communicates with the imaging system 107.

The user interface 110 includes a display 112 for displaying images from the imaging system 107. The display 112 includes a resolution capable of displaying a diagnostic image or movie. One or more buttons 114 are provided for controlling the imaging module 108 and/or manipulating the images on the display 112. The buttons 114 may be provided in a keypad 116 that is separate from the display 112. Alternatively, the display 112 may be a touch-screen display having the buttons 114 incorporated therein (e.g. virtual buttons). In one embodiment, the user interface 110 also includes a functional directional controller 118 and at least one accelerometer 120. A communication device 122 is also provided for communicating with the imaging system 107 and/or other modules, for example, the workstation 102 or the registration module 106, such as a transceiver for wireless communication. The communication device 122 may be configured so as to not interfere with the imaging module 108. For example, the communication device 122 may be a Bluetooth device or the like. The communication device 122 may also communicate using a digital protocol for transmitting information and commands between the user interface 110 and the imaging system 107.

In one embodiment, the user interface 110 includes an audio device 124, for example, a speaker and a microphone. The audio device 124 is in communication with a corresponding audio/video device (e.g. integrated headphones 111 and/or a LED display 113 (shown in FIG. 1)) positioned within the imaging system 107. The audio device positioned within the imaging system 107 may be positioned in proximity to the patient table to enable two way communications between the operator and the patient. For example, the audio device 124 may be used to instruct the patient to hold their breath, move, rotate, hold still, or the like. The audio device 124 may also be used to ask the patient questions and/or update the patient on a status of the scan.

The user interface 110 may also display icon-based menus on the display 112 for controlling the imaging system 107. The icon-based menus may be hierarchal menus, for example, the menu 125 shown in FIG. 3. The icons may have images to facilitate easier identification of associated functions, etc. The icons may also be configured as one-touch virtual buttons 127, as shown in FIG. 3. The icon driven user input allows the user interface 110 to control the imaging system 100 (shown in FIG. 1) or other connected devices. Commands are sent to the imaging module 108, which may be based on selections from the menus or other user inputs. A processor and/or computer within the imaging module 108 reads the commands from the user interface 110. The command is propagated to an appropriate scanner subsystem for execution, such as the imaging module 108 of the imaging system 107 of FIG. 1. In one embodiment, the imaging module 108 verifies whether the imaging system 107 is capable of executing the command at that time. If further instructions are required, the processor of the imaging module 108 sends a command to the user interface 110. In response a new menu is displayed on the user interface 110. For example, after image acquisition, a new menu may be displayed that enables the operator of the user interface 110 to request that an image be transmitted to the user interface 110 for display on the display 112. In one embodiment, the user may also manually select different screens, controls, etc.

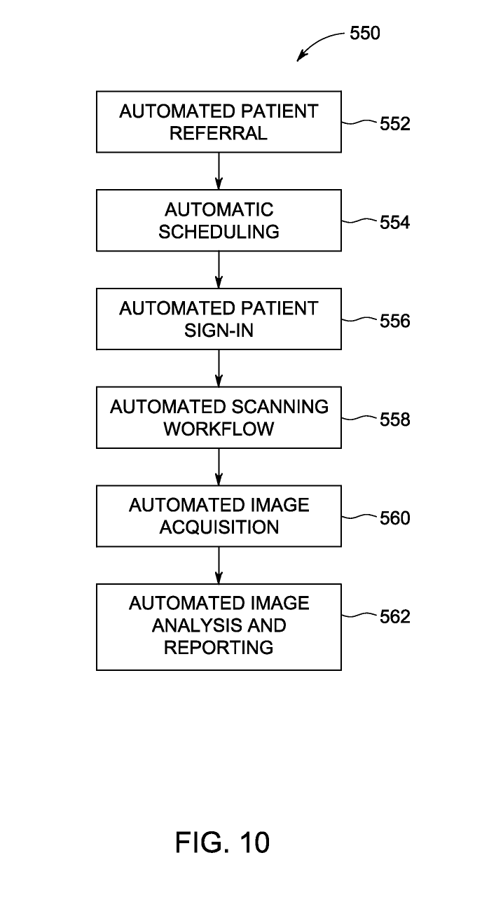

Referring now specifically to FIG. 3, a view of a menu 125 is shown displayed on the user interface 110. The user interface 110 may include one or more one-touch virtual buttons 127 for selecting from the menu 125. Alternatively, the user interface 110 may include an icon driven user input, as shown in FIG. 10. The user interface 110 may be used to control the imaging system 100 and/or other connected devices.

Referring back to FIG. 2, the user interface 110 may be used to control a MRI scanner in an embodiment. The functional directional controller 118 and at least one accelerometer 120 within the user interface 110 may be utilized to manually control a current scan plane of the imaging system 107 in real-time. For example, the scan plane may be steered by an operator of the user interface 110 by manipulating the user interface in three-dimensions. Accordingly, the user interface 110 may be used as a virtual joystick control. The user interface 110 is manipulated by rotating and moving the user interface 110. Information indicative of the orientation of the user interface 110 is sent continuously to the imaging module. The information is used to control a center point and corner points of the scan plane. In another embodiment, wherein the display 112 is a touch screen display, the current scan plane may be controlled by manipulating the image on the touch screen or through virtual buttons or a virtual joystick. In one embodiment, the user interface may also be used to control MRI scan parameters in a real-time during image acquisition. The functional directional controller 118 may also be used to control the scan plane, window/level or positioning of the patient table.

The user interface 110 enables review of the images acquired with the imaging system 107 during image acquisition and while the operator is moving. The images may be manipulated on the user interface 110 to identify or determine diagnostically relevant information. In one embodiment, the user interface 110 can direct higher spatial resolution images to be displayed on an adjacent high resolution monitor, for example a monitor positioned in or around the imaging room. Additionally, the user interface may display physiological parameters of the patient, such as an electrocardiogram signal from the wireless electrocardiogram 109 (shown in FIG. 1), a respiration signal, an oxygen saturation signal, or the like.

The user interface 110 provides a convenient and intuitive device for controlling the imaging system 107. All image module functions may be available from the user interface 110, including image review. In one embodiment, the user interface 110 may be configured to work with additional scan-room image display devices, interventional devices, patient electrocardiogram display devices, or the like.

In some embodiments, the user interface 110 incorporates audio recording functions, still photography functions, and movie acquisition functions. Accordingly an operator, physician or the like may record audio and photographic notes on the patient report. Additionally, the user interface 110 may record vital information, for example, an electrocardiogram of the patient, a respiratory rate of the patient, an oxygen pressure of the patient, or the like. The notes and vital information are saved in a digital record of the scan. In some embodiments, the user interface 110 includes memory, which may be internal or removable, for saving images, notes, vital information, etc. The notes and vital information may be transmitted to the workstation 102 (shown in FIG. 1) for review by the patient's primary physician.

The user interface 110 may also be capable of scanning the patient information card 104 or a tag attached to the patient, for example an identification wristband or an RFID tag. The patient information is retrieved by the user interface 110 and transmitted to the imaging module 108, thereby eliminating the need for the patient information to be manually entered by an operator. Additionally, the patient information card 104 may also contain the scan information, which, when read by the user interface 110, is transmitted to the imaging module 108. The imaging module 108 may automatically set the scan parameters for the patient scan and may automatically execute the patient scan.

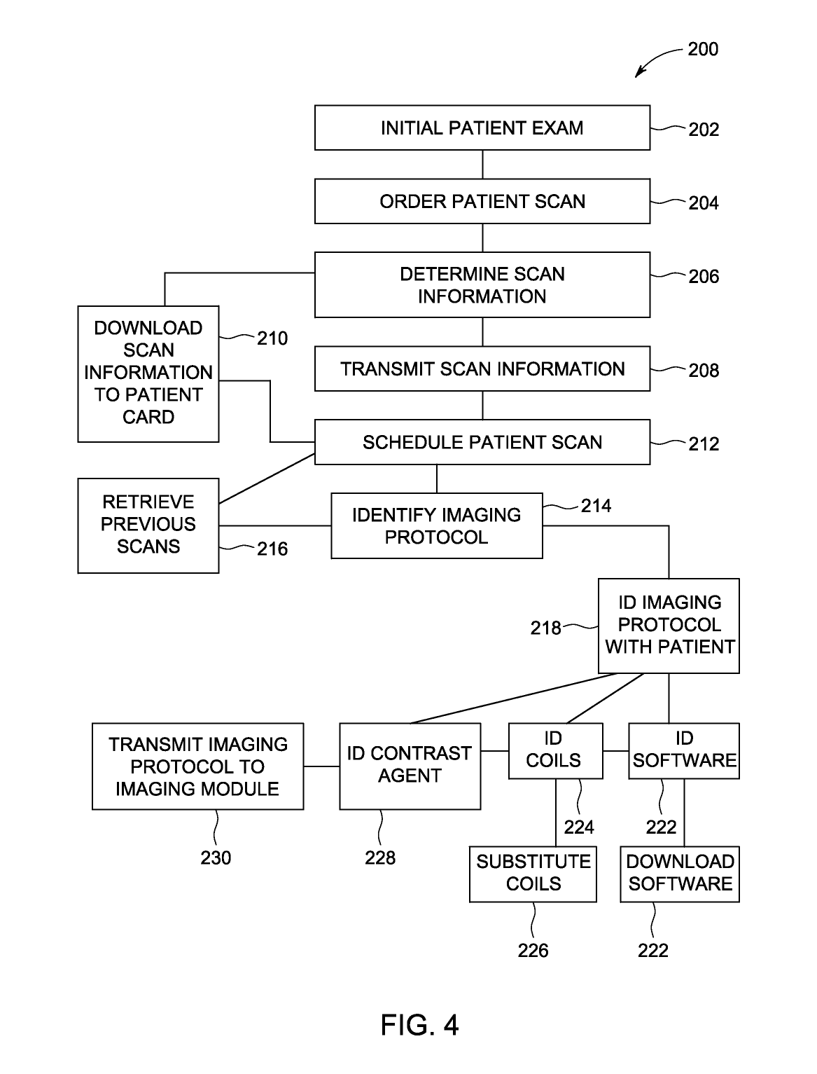

FIG. 4 is a flowchart of a method 200 of scheduling using the system 100 in accordance with an embodiment. The method 200 includes an initial patient examination at 202. The initial patient examination takes place, for example, at a physician's office where the physician has access to the workstation 102 (shown in FIG. 1). During the initial patient examination, the physician determines a type of patient scan to be performed. The physician orders the patient scan at 204. Ordering the patient scan includes entering the scan order information into the workstation 102 (and optionally, the patient information). The workstation 102 may have access to images, radiologist reports, or the like from previous patient scans. The physician may use this information in determining a purpose for the new scan or the specific type of scan or region to be scanned.

At 206, a processor of the workstation 102 automatically determines the scan information including scan parameters for the patient scan, for example using a database of scan parameters and scan information. For example, the workstation 102 may determine a type of scan to be used, a type of coil to be used, pulse sequences for the scan, or other related scan parameters. The workstation 102 is linked to the registration module 106 (shown in FIG. 1). In one embodiment, the workstation 102 and the registration module 106 are linked by a common platform or software, which may be any suitable software for providing electronic interfacing and communication. The workstation 102 automatically electronically transmits the patient information and the scan information to the registration module 106 at 208. The patient information and scan information may be wirelessly transmitted. In addition, the patient information and the scan information is downloaded to the patient information card 104 (shown in FIG. 1) at 210 through a card scanner or the like.

At 212, the registration module automatically schedules the patient scan for increased efficiency. For example, the patient scan may be scheduled along with groups of scans for a specific anatomy or imaging modality, such as for a particular scanner. Accordingly, the group of scans can be performed within the same time frame, thereby reducing downtime during scanning procedures. At 214, the registration module 106 identifies an imaging protocol for the patient scan. Optionally, at 216, the registration module 106 may automatically retrieve previous patient scan studies to determine the necessary imaging protocol. At 218, the imaging protocol is associated with the patient. At 220 the registration module 106 identifies imaging system software required for the imaging protocol, for example software for controlling the imaging system 107 or the scan parameters. If the software is not currently available on the imaging system 107 (shown in FIG. 1), the registration module 106 may download the required software at 222 from a licensed server. If software is downloaded, an administration official is automatically notified.

At 224, the registration module 106 identifies the radio-frequency coils required for the imaging protocol. If the necessary coils are not available, the registration module 106 may optionally identify, at 226, substitute coils that may be used for the patient scan. An administration official within the imaging facility is automatically notified of the requirement to utilize substitute coils. Next, the registration module 106 automatically identifies, at 228, contrast agent compatibility, if any, based on the patient information and the scan information. A contrast agent for the patient scan is added to the imaging protocol.

At 230, the registration module 106 transmits the imaging protocol to the imaging module 108. In one embodiment, the registration module 106 transfers all data setup, the imaging protocol, etc. The imaging protocol may be electronically transmitted. In one embodiment, the imaging protocol is wirelessly transmitted. Additionally, the imaging protocol may be downloaded to the patient information card 104.

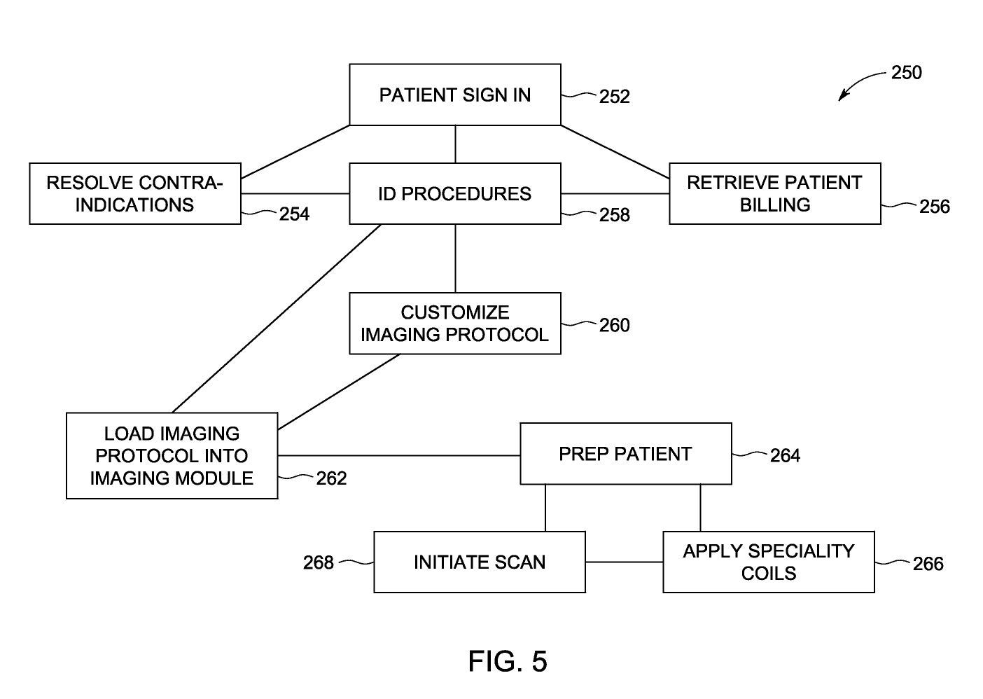

After the scan is ordered, patient registration is performed. FIG. 5 is a flowchart of a method 250 of patient registration using the system 100 in accordance with an embodiment. In this embodiment, the patient sign in is at an imaging facility or hospital having imaging scanners. At 252, the patient signs in at the imaging facility. In an exemplary embodiment, the patient signs in using the patient information card 104 (shown in FIG. 1). The imaging facility includes a card reader capable of retrieving the patient information from the patient information card 104. The patient is identified along with the imaging protocol for the patient scan. In one embodiment, the imaging protocol may have been previously transmitted to the imaging facility. In such an embodiment, the patient is identified and linked to the corresponding imaging protocol. At 254, any contra-indications between the previously received information and the information on the patient information card 104 may be resolved by updating the patient information. At 256, the patient's billing and insurance information may be retrieved based on the patient information and the later updated when the scans are performed to bill the appropriate entity or person.

At 258, procedures for the imaging protocol are identified. For example, the patient information may identify special orders for the patient, for example, claustrophobia, excessive weight, a need for a breathing coach, medications, allergies, or the like. Anesthesia orders, electrocardiogram needs and other needs may also be identified. At 260, the imaging protocol is automatically customized based on any special orders. The imaging protocol may also be customized based on limitations of the imaging facility. For example, the imaging protocol may be customized based on the type of imaging facility (i.e. imaging center, trauma center, inpatient imaging, etc.). In one embodiment, the imaging protocol is customized by allowing for multi-modality integration.

At 262, the imaging protocol is loaded onto the imaging module 108 (shown in FIG. 1). The image protocol may be loaded by reading the patient information card 104 (shown in FIG. 1) at a card reader incorporated into the imaging system 107. Alternatively, the imaging protocol may have been previously transmitted to the imaging module from when the patient signed in or, alternatively, when the scan was ordered. In such an embodiment, the patient is identified with the patient information card 104 and the imaging protocol corresponding to the patient is loaded onto the imaging system 107 (e.g. automatic setup of the imaging scanner).

At 264, the patient is prepped for the patient scan based on the imaging protocol. For example an electrocardiogram may be connected to the patient, anesthesia may be provided, a contrast agent may be injected, or the like. At 266, specialty coils may be applied to the patient. For example, knee or shoulder coils may be applied. At 268 the scan is initiated using the user interface 110 (shown in FIG. 1). In an embodiment wherein the user interface 110 is a hand held device, the scan can be performed with no operator in the room. Additionally, a technologist can remain with patient at all times.

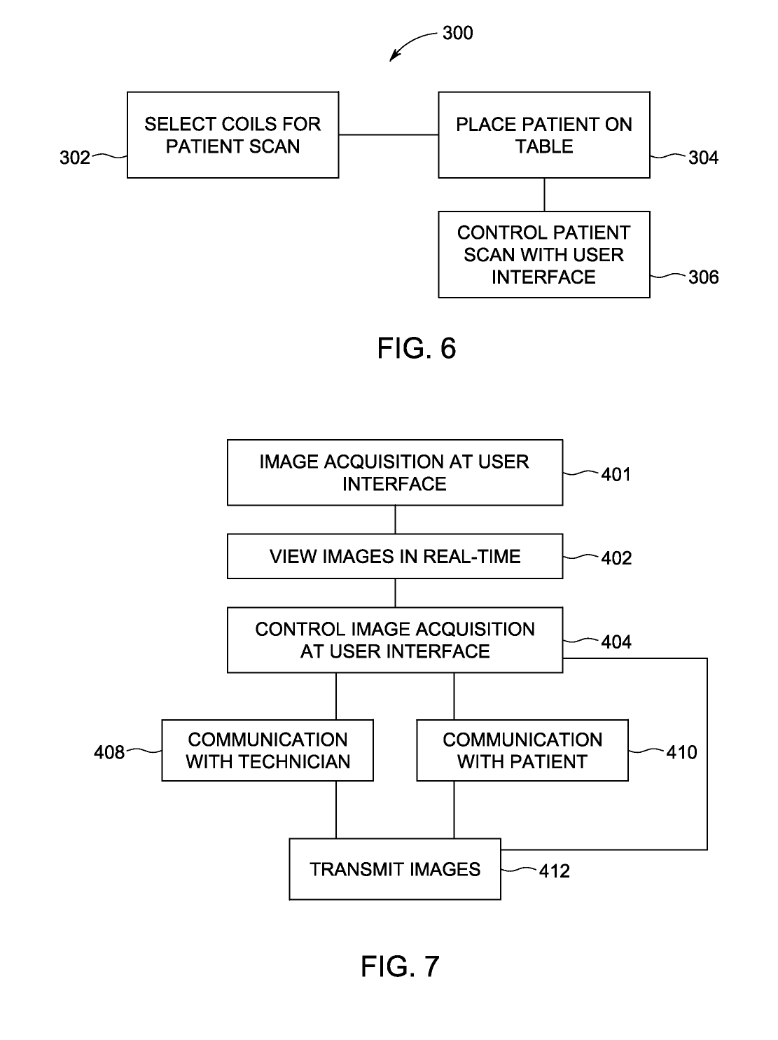

After patient registration, scanning is performed. FIG. 6 is a flowchart of a method 300 for scanning workflow using the system 100 in accordance with an embodiment. At 302, the imaging module automatically selects coils for the patient scan based on the imaging protocol. At 304, the patient is placed on the patient table and the scan is initiated using the user interface 110 and the imaging system 107 locates the target anatomy based on the image protocol. The imaging system 107 automatically performs the scan based on the imaging protocol. For example, the scan may be started using a one-touch display on the user interface 110. The one-touch display may include buttons, for example, virtual buttons, that designate a type of scan or scan protocol. By selecting a single button, the scan is started based on the designated type of scan or scan protocol. The imaging module 108 may determine an entry position and/or an orientation of the patient as the patient is advanced into the imaging system 107. In one embodiment, the imaging module automatically determines a weight of the patient and coil positioning.

The patient scan is controlled at the user interface 110, at 306. With the user interface 110, the operator may also review the imaging protocol and control external displays. For example, the operator may use the user interface 110 to transmit high resolution images to large screen displays in the imaging room and/or outside the imaging room.

After scanning, image acquisition is performed. FIG. 7 is a flowchart of a method 400 of image acquisition using the system 100 in accordance with an embodiment. In an exemplary embodiment, image acquisition is performed, at 401, using the user interface 110 (shown in FIG. 1 and as described above). At 402, the operator views the images generated from the acquired image data in real-time on the user-interface. At 404, the operator controls the image acquisition using the user interface 110. For example, the operator may adjust and/or rotate the image scan plane by manipulating (i.e. moving and rotating) a hand-held user interface 110. Alternatively, the user interface 110 may include a touch-screen display 112 (shown in FIG. 1). The operator may manipulate the touch-screen display to change the scan plane. Also, the operator may adjust the scan parameters using a menu, for example, the menu 125 (shown in FIG. 3). In one embodiment, the operator may narrow the image acquisition based on an observed or detected problem, for example, an anomaly within the images or imaged structure. The expert system then determines a scan protocol that can be applied to acquire additional information about the anomaly. The operator may utilize the user interface 110 to initiate the scan protocol for imaging the anomaly. For example, the operator may utilize a one-touch button on the user interface 110 to initiate the scan protocol. By determining additional information about the anomaly during image acquisition, future patient call backs for further imaging may be reduced or eliminated. In another embodiment, the expert system within the imaging system 107 or the user interface 110 may automatically detect the anomaly using a suitable image processing technique that identifies image anomalies or structures of interest. In such an embodiment, the expert system may automatically initiate a new scan protocol to image the anomaly.

In one embodiment, the operator may also control other operations or parameters, for example movement of the patient table, etc. The operator may use the communication device 122 to communicate with a technician in the imaging room, at 408. In addition, the operator may communicate with the patient, at 410, using the audio device 124. At 412, the operator may transmit the image data and/or commands to the workstation 102 (shown in FIG. 1) for review by the primary physician. It should be noted that the operator and the technician may be the same or different people.

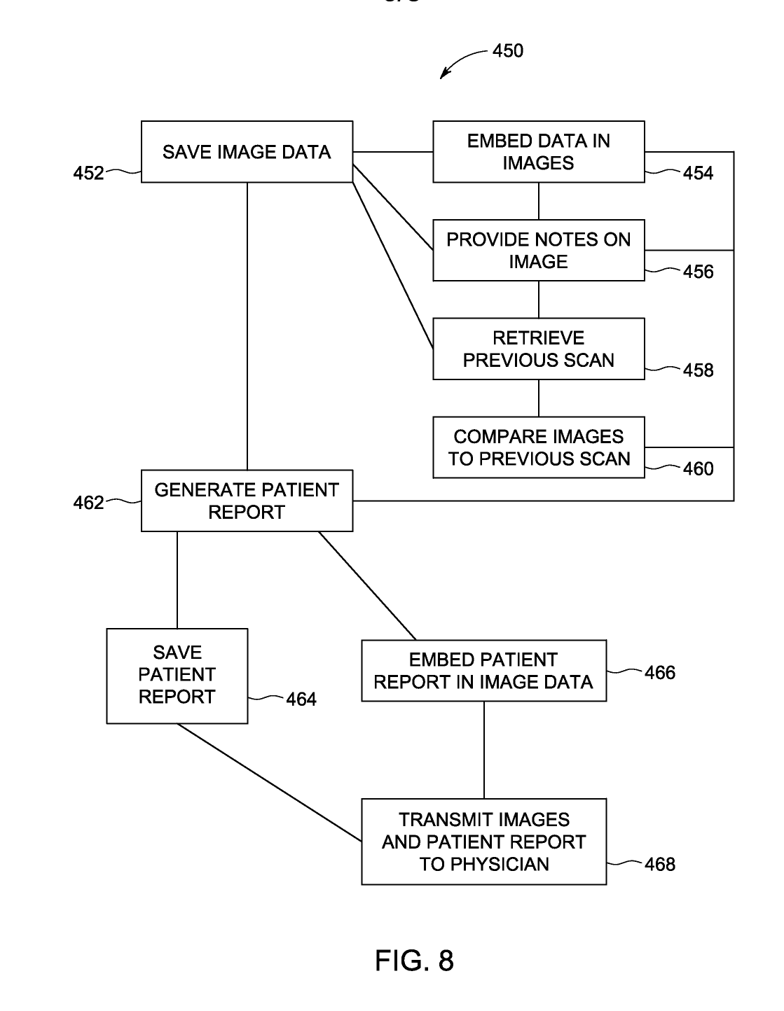

After image acquisition, image analysis is performed. FIG. 8 is a flowchart of a method 450 for image analysis and reporting using the system 100 in accordance with an embodiment. The image analysis may be performed at the imaging facility, at the workstation 102 (shown in FIG. 1), and/or at a remote facility. Imaging data acquired by the imaging system 107 during the scan is stored at 452. In an exemplary embodiment, the imaging data is stored in a Digital Imaging and Communications in Medicine (DICOM) format, for example, as DICOM images. Optionally, the scan commands entered into the user interface 110 by the operator may be embedded into the DICOM images. In one embodiment, the DICOM images are stored within the imaging facility in a centralized database or the like. Alternatively, the DICOM images may be stored within a healthcare network and/or a third party storage facility.

Data related to the imaging data may also be embedded into the DICOM images at 454. For example, in a stroke analysis, the diffusion/perfusion weighted image mismatch, the regional cerebral blood volume, and/or the infarct size may be embedded within the DICOM image. For a musculoskeletal analysis, data related to the patient's cartilage may be embedded within the DICOM image. For a cardiac analysis, data related to an ejection fraction, wall motion, perfusion, infarct size/gray zone, and/or a myocardial perfusion reserve may be embedded within the DICOM image. In an oncology analysis, data related to a rate constant and/or permeability may be embedded within the DICOM image. In a spinal analysis, auto vertebral labeling may be embedded within the DICOM image. For a neurology analysis, a white matter mass/volume may be embedded within the DICOM image. In a vascular analysis auto vessel segmentation data may be embedded within the DICOM image. At 456, a technician and/or physician may provide notes related to the images. The notes may be entered as text using the user interface and/or the notes may include audio recordings. The notes may also be embedded in the DICOM image.

At 458, the imaging module 108 may retrieve previous patient images and patient reports. For example, the previous patient images and patient reports may be requested using the user interface 110. At 460, the previous images and reports may be compared to the current scan to gauge progress and/or changes within the patient. At 462, a patient report is generated. The patient report may be generated by a radiologist, a physician, and/or the primary physician at the workstation 102. The patient report is saved, at 464, within the user interface 110, the workstation 102, or at a remote memory device. Alternatively, the patient report may be embedded within the DICOM image, at 466. In an exemplary embodiment, the DICOM images and the patient report are downloaded onto the patient information card 104 (shown in FIG. 1). The DICOM images and the patient report may be electronically transmitted to the primary physician and displayed at the workstation 102, at 468. Optionally, the patient may return to the primary physician, where the DICOM images and the patient report are retrieved from the patient information card 104.

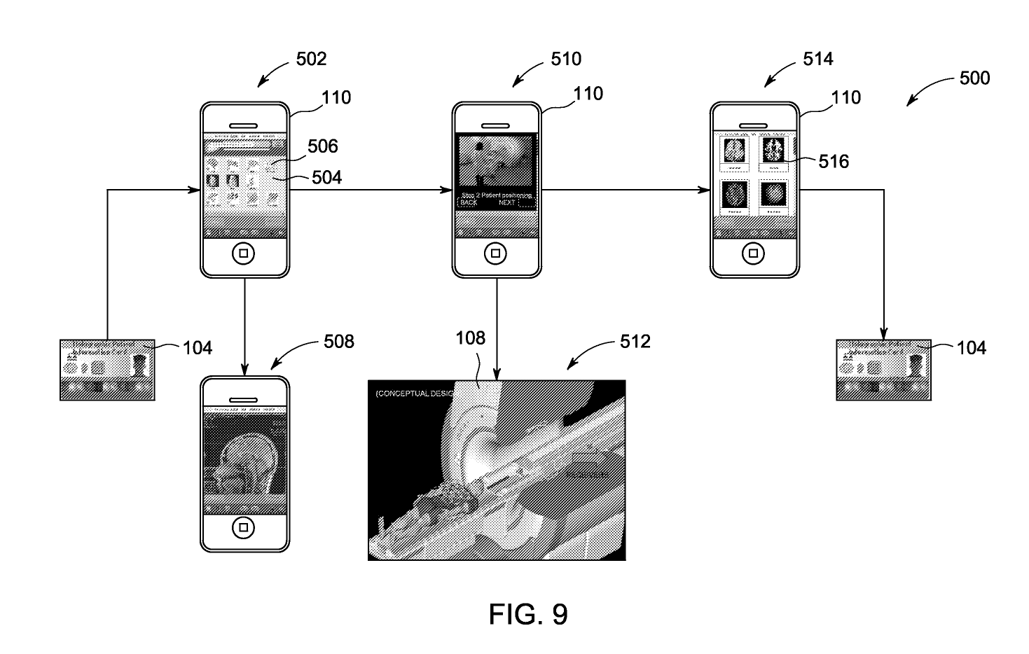

FIG. 9 is a schematic block diagram 500 illustrating imaging workflow in accordance with various embodiments. The user interface 110 retrieves the patient information and the scan information from the patient information card 104, for example, by scanning the patient card. Alternatively, the patient information and the scan information may be electronically delivered from the workstation 102 (shown in FIG. 1) and/or the registration module 106 (shown in FIG. 1). In the illustrated embodiment, the user interface 110 is a portable device. During a scanning workflow stage 502, the user selects a scan type from a one-touch display 504. The one-touch display includes icons 506 corresponding to a scan type. The user selects an icon 506 based on the patient information and the scan information. In one embodiment, the user interface 110 may automatically populate icons 506 based on the patient information and the scan information. Upon selecting an icon 506, the scan is started and the user receives scan verification on the user interface 110 at 508, such as an initial image.

During an image acquisition stage 510, the user may operate the user interface 110 to control image acquisition. For example, the user interface may provide visual confirmation of the patient's position, as shown at 510. The user may interface with the display 512 to operate the imaging system 100, for example, by controlling scan parameters, controlling patient table movement, or by monitoring the patient. Alternatively, the user may manipulate the user interface 110 to operate the imaging system 107. For example, the user may manipulate a handheld user interface to operate the imaging system 107.

At an image analysis stage 514, the user interface 110 may be populated with various images acquired by the imaging system 107. The images may be presented as icons 516 (e.g. thumbnail images) that are selectable by the user to provide a full-screen view of the images. Optionally, the user may select multiple images for viewing to compare the images. At the image analysis stage 514, the user may add a report, notes or recorded audio that are saved with the images. The images may then be downloaded onto the patient information card 104 for future retrieval. Optionally, the images may be electronically transmitted to the workstation 102 and/or any other module or memory system.

FIG. 10 is a flowchart illustrating a method 550 for imaging workflow in accordance with various embodiments. The method 550 provides automated workflow for patient imaging. Each of the steps of the method 550 may be performed without user intervention. At 552, the method 550 includes an automated patient referral, wherein an exam order from a prescribing physician is downloaded to a patient information card. The exam order includes scan information and patient information. The exam order is automatically and electronically transmitted to an imaging center. At 554, the patient scan is automatically scheduled at the imaging center based on a type of exam requested, a clinical need, and/or an availability of resources. Imaging hardware, software, pharmacological agents, and the like needed for the requested scan are identified, and alerts are generated for missing components. Relevant prior studies of the patient also may be automatically retrieved from an imaging archive.

The method 550 provides automated patient sign in at 556. The patient information and the scan information are retrieved from the patient information card and loaded on an imaging module. Information, such as custom procedures and workflow for patient preparation, side effects, contra-indications, training and coaching are automatically retrieved from the patient information card. Additionally, hardware setup (e.g. coils, monitoring equipment, etc.) and an imaging protocol are automatically selected based on the patient information and the scan information. Moreover, patient billing and accounting may be automatically determined based on information on the patient information card.

The method 550 also provides automated scanning workflow for an imaging system at 558. The automated scanning workflow may include automatic selection of coils, imaging location and orientation, patient position, weight, etc. The system may be equipped with integrated systems of headphones, displays, and cameras, for patient compliance, entertainment, and monitoring of motion. Simple, touch screen controls for the operator and large displays, both in the imaging room and in the operator room may be provided. The method 550 also provides automated image acquisition at 560. The system may include remote assistance from an expert center and/or third party expert center. The system enables remote control of the scan and the ability to remotely visualize the patient, scan room, and/or images. The system may also provide single button help based on the current exam type.

The method 550 also provides automated image analysis and reporting at 562. The system may automatically create multimedia patient reports and analysis of changes from prior patient studies. The system automatically electronically transmits the generated reports and image data back to referring physician.

At least one technical effect of various embodiments includes providing a simplified and automated workflow for conducting diagnostic imaging examinations of a patient.

Various embodiments include automated management of a patient imaging protocol and scheduling based on scan information and patient information provided by a prescribing physician. The various embodiments may include a plurality of authorization levels that restrict the access of certain individuals from at least some of the patient information and scan information. The various embodiments include automated imaging workflow including patient positioning, coil selection, imaging location and orientation selection, and the like. Control and optimization of imaging parameters relevant to patient scan are also automated. The system also manages and corrects sources of image artifacts, such as patient motion. The system also provides automatic analysis and computation of required clinical information and creation of multi-media reports. The reports include comparisons with prior studies of the patient, and may include combined analysis with other modalities of imaging.

Various embodiments described herein provide a tangible and non-transitory machine-readable medium or media having instructions recorded thereon for a processor or computer to operate an imaging apparatus to perform an embodiment of a method described herein. The medium or media may be any type of CD-ROM, DVD, floppy disk, hard disk, optical disk, flash RAM drive, or other type of computer-readable medium or a combination thereof.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the folio of an information source or a physical memory element within a processing machine.

The set of instructions may include various commands that instruct the computer or processor as a processing machine to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the described subject matter without departing from their scope. While the dimensions and types of materials described herein are intended to define the parameters of the various embodiments of the invention, the embodiments are by no means limiting and are exemplary embodiments. Many other embodiments will be apparent to one of ordinary skill in the art upon reviewing the above description. The scope of the various embodiments of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable one of ordinary skill in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An imaging workflow system comprising:
a workstation for acquiring patient information and requesting a patient scan, wherein the request for a patient scan includes scan information for performing the patient scan;
a registration module for receiving the scan information and the patient information, the registration module automatically scheduling the patient scan based on the scan information and the patient information, the registration module determining an imaging protocol based on the patient information and the scan information;
an imaging module within an imaging system receiving the imaging protocol, the imaging module automatically setting scan parameters based on the imaging protocol, the imaging system scanning the patient based on the scan parameters to acquire image data; and
a user interface for controlling the patient scan, the user interface including a display to display images generated from the acquired image data.

2. The system of claim 1, wherein the system operates without user intervention.

3. The system of claim 1, wherein the user interface is a portable device that wirelessly communicates with at least one of the workstation, the registration module, or the imaging module.

4. The system of claim 1, wherein at least one of the patient information and the scan information is downloaded to a patient information card.

5. The system of claim 1, wherein the user interface is a portable device that includes icon-based menus for controlling operation of the imaging system.

6. The system of claim 1, wherein the scan information includes a high-level scan request, at least one of the registration module or the imaging module including logic to translate the high-level scan request to a specific scan request.

7. The system of claim 1, wherein the user interface is a portable device that includes a directional controller that allows control of imaging scan planes for scanning the patient with the imaging system.

8. The system of claim 1, wherein the user interface is a portable device having an accelerometer that enables control of the patient scan by moving the user interface to control the imaging system.

9. A method for providing imaging workflow comprising:
automatically scheduling a patient scan based on acquired patient information and scan information for performing the patient scan;
automatically determining an imaging protocol based on the scan information and the patient information;
automatically setting scan parameters based on the imaging protocol;
scanning the patient based on the scan parameters to acquire image data;
controlling the patient scan at a user interface; and
displaying images generated from the acquired image data on a display.

10. The method of claim 9, wherein the method is performed without user intervention.

11. The method of claim 9 further comprising downloading at least one of the patient information or the scan information to a patient information card.

12. The method of claim 9 further comprising:
automatically determining procedures and equipment required for the patient scan based on the patient information and the scan information; and
scheduling the patient scan based on the required procedures and equipment.

13. The method of claim 9, wherein the user interface is a portable device that includes icon-based menus, the method further comprising controlling operation of the patient scan with the icon-based menus.

14. The method of claim 9, wherein the scan information include a high-level scan request, the method further comprising translating the high-level scan request to a specific scan request.

15. The method of claim 9, wherein the user interface is a portable device that includes a directional controller, the method further comprising controlling imaging scan planes of an imaging system used to perform the patient scan with the directional controller.

16. The method of claim 9, wherein the user interface is a portable device having an accelerometer, the method further comprising controlling the patient scan by moving the user interface so that the accelerometer controls an imaging system used to perform the patient scan.

17. The method of claim 9, further comprising initiating a new imaging protocol based on a detected anomaly within the displayed images.

18. A non-transitory computer readable storage medium for providing imaging workflow using a processor, the non-transitory computer readable storage medium including instructions to command the processor to:
automatically schedule a patient scan based on acquired patient information and scan information for performing the patient scan;
automatically determine an imaging protocol based on the acquired patient information and the scan information;
automatically set scan parameters based on the imaging protocol;
scan the patient based on the scan parameters to acquire image data; and
display images generated from the acquired image data on a display.

19. The non-transitory computer readable storage medium of claim 18, wherein the instructions command the processor to enable control of an imaging system used to scan the patient with a portable user interface having a directional controller that controls imaging scan planes of the imaging system.

20. The non-transitory computer readable storage medium of claim 18, wherein the instructions command the processor to enable control of an imaging system used to scan the patient with a portable user interface having an accelerometer that controls the imaging system by moving the user interface.

21. The non-transitory computer readable storage medium of claim 18, wherein the instructions command the processor to control the patient scan without user intervention.
